(19) United States
(12) Patent Application Publication
(10) Pub. No.: US 2008/0266102 A1
(43) Pub. Date: Oct. 30, 2008

(54) Methods and Apparatus for an RF Port with Removeable Submodules

(75) Inventor: Ajay Malik, San Jose, CA (US)

Correspondence Address: INGRASSIA FISHER & LORENZ, P.C., 7010 E. COCHISE ROAD, SCOTTSDALE, AZ, 85253, US

(73) Assignee: SYMBOL TECHNOLOGIES, INC., Holtsville, NY (US)

(21) Appl. No.: 11/741,922

(22) Filed: Apr. 30, 2007

(51) Int. Cl. G08B 13/14

(52) U.S. Cl. 340/572.7

(57) ABSTRACT

An RF port device includes a digital module within a housing, wherein the digital module is configured to communicate with a network over a data connection (e.g., a GigE Ethernet connection), from which it may receive power. The digital module and housing are configured to removeably couple to two or more RF submodules—e.g., RFID reader submodules, 802.11 a/b/g access port submodules, 802.11n access port submodules, Wi-MAX submodules, Ultra Wide Band submodules, and Bluetooth submodules.

### TECHNICAL FIELD

The present invention relates generally to radio frequency identification (RFID) systems, wireless local area networks (WLANs), and other RF components. More particularly, the invention relates to compact, modular RF systems.

### BACKGROUND

Radio frequency identification (RFID) systems have achieved wide popularity in a number of applications, as they provide a cost-effective way to track the location of a large number of assets in real time. In large-scale application such as warehouses, retail spaces, and the like, many RFID tags may exist in the environment. Likewise, multiple RFID readers are typically distributed throughout the space in the form of entryway readers, conveyer-belt readers, mobile readers, etc.

At the same time, there has been a dramatic increase in demand for mobile connectivity solutions utilizing various wireless components and wireless local area networks (WLANs). This generally involves the use of wireless access points that communicate with mobile devices using one or more RF channels (e.g., in accordance with one or more of the IEEE 802.11 standards).

The number of mobile units and associated access ports, as well as the number of RFID readers and associated antennae, can be very large in an enterprise. Such systems take up a significant amount of space, and can be difficult to place correctly. That is, it is often necessary to mount RFID readers, APs, and the like at nearly every exit and entrance to a room. This often requires special mounting requirements and power facilitation.

Accordingly, it is desirable to provide compact RF component systems that can be configured in a variety of ways and which can be deployed pervasively throughout an environment. Furthermore, other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a system in accordance with an exemplary embodiment of the present invention;

FIG. 2 is a conceptual overview of an exemplary RF switch in accordance with one embodiment;

FIG. 3 depicts various functional domains of the present invention; and

FIG. 4 depicts various components of an exemplary system in accordance with the present invention.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, wireless networks, RFID systems and specifications, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

Without loss of generality, in the illustrated embodiment, many of the functions usually provided by a traditional access point (e.g., network management, wireless configuration, locationing of wireless devices, active 802.11 tags, etc.) and/or traditional RFID readers (e.g., data collection, RFID processing, etc.) are concentrated in a corresponding RF switch. It will be appreciated that the present invention is not so limited, and that the methods and systems described herein may be used in conjunction with traditional access points and RFID readers or any other device that communicates via RF channels.

The present invention relates to a RF port device incorporating interchangeable RF submodules that can be configured to provide a variety of functions, and which are small enough to be placed in Ethernet jacks, power outlets, and the like.

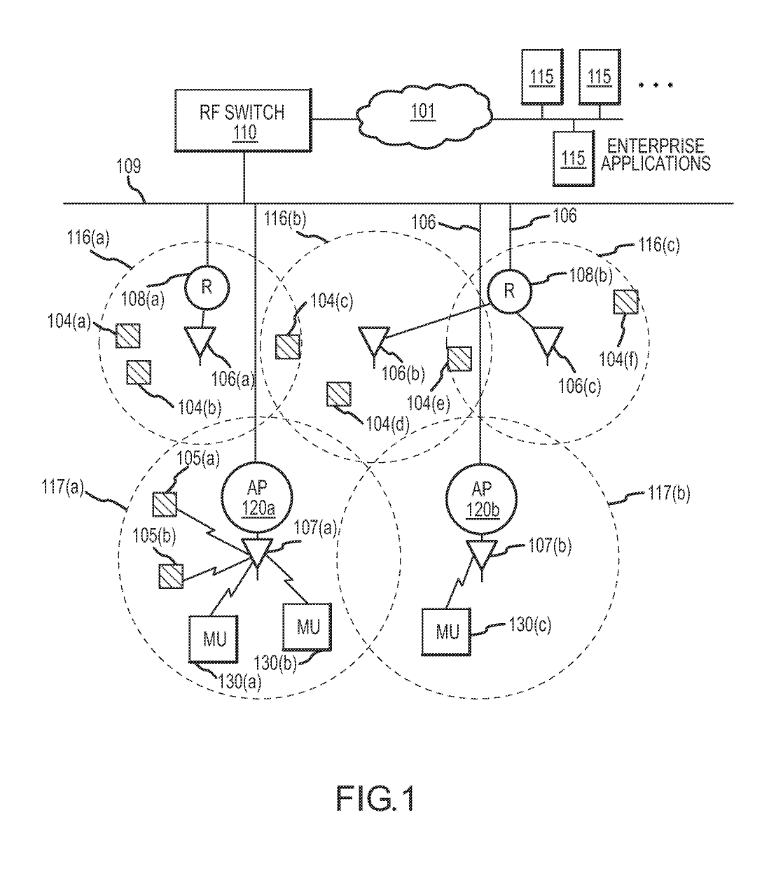

Referring to FIG. 1, a switching device 110 (alternatively referred to as an “RF switch” or simply “switch”) is coupled to a networks 101 and 109 (e.g., an Ethernet network coupled to one or more other networks or devices) which communicates with one or more enterprise applications 115. One or more wireless access ports 120 (alternatively referred to as “access ports” or “APs”) are configured to wirelessly connect to one or more mobile units 130 (or “MUs”). APs 120 suitably communicate with switch 110 via appropriate communication lines 106 (e.g., conventional Ethernet lines, or the like). Any number of additional and/or intervening switches, routers, servers and other network components may also be present in the system.

A number of tags 104 are distributed throughout the environment. These tags are read by a number of RFID readers (or simply “readers”) 108 having one or more associated antennas 106 provided within the environment. Tags 104 may also be read by APs 120 that read active tags, or by an ultra-wideband APS, or the like. That is, the term “tag” refers to any RF element that can be communicated with and which has an ID that can be read. Readers 108, like APs 120, may be stationary or mobile, and are suitably connective via wired or wireless data links to a RF switch 110.

A particular AP 120 may have a number of associated MUs 130. For example, in the illustrated topology, MUs 130(a) and 130(b) are associated with AP 120(a), while MU 130(c) is associated with AP 120(b). One or more APs 120 may be coupled to a single switch 110, as illustrated.

RF Switch 110 determines the destination of packets it receives over network 104 and 101 and routes those packets to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110. AP 120 is typically capable of communicating with one or more MUs 130 through multiple RF channels. This distribution of channels varies greatly by device, as well as country of operation. For example, in one U.S. embodiment (in accordance with 802.11(b)) there are fourteen overlapping, staggered channels, each centered 5 MHz apart in the RF band.

A particular RFID reader 108 may have multiple associated antennas 106. For example, as shown in FIG. 1, reader 108(a) is coupled to one antenna 106(a), and reader 108(b) is coupled to two antennas 106(b) and 106(c). Reader 108 may incorporate additional functionality, such as filtering, cyclic-redundancy checks (CRC), and tag writing, as is known in the art.

In general, RFID tags (sometimes referred to as “transponders”) may be classified as either active or passive. Active tags (e.g., tags 105) are devices that incorporate some form of power source (e.g., batteries, capacitors, or the like), while passive tags are tags that are energized via an RF energy source received from a nearby antenna. While active tags are more powerful, and exhibit a greater range than passive tags, they also have a shorter lifetime and are significantly more expensive. Such tags are well known in the art, and need not be described in detail herein.

Each antenna 106 has an associated RF range (or “read point”) 116, which depends upon, among other things, the strength of the respective antenna 106. The read point 116 corresponds to the area around the antenna in which a tag 104 may be read by that antenna, and may be defined by a variety of shapes, depending upon the nature of the antenna (i.e., the RF range need not be circular or spherical as illustrated in FIG. 1).

It is not uncommon for the RF ranges or read points to overlap in real-world applications (e.g., doorways, small rooms, etc.). Thus, as shown in FIG. 1, read point 116(a) overlaps with read point 116(b), which itself overlaps with read point 116(c). Accordingly, it is possible for a tag to exist within the range of two or more readers simultaneously. For example, tag 104(c) falls within read points 116(a) and 116(b), and tag 104(f) falls within read points 116(b) and 116(c). Because of this, two readers (108(a) and 108(b)) may sense the presence of (or other event associated with) tag 104(c).

Switch 102 includes hardware, software, and/or firmware capable of carrying out the functions described herein. Thus, switch 102 may comprise one or more processors accompanied by storage units, displays, input/output devices, an operating system, database management software, networking software, and the like. Such systems are well known in the art, and need not be described in detail. Switch 102 may be configured as a general purpose computer, a network switch, or any other such network host. In a preferred embodiment, controller 102 is modeled on a network switch architecture but includes RF network controller software (or “module”) whose capabilities include, among other things, the ability to allow configure and monitor readers 108 and antennas 106.

RF switch 110 allows multiple read points 116 to be logically combined, via controller 102, within a single read point zone (or simply “zone”). For example, referring to FIG. 1, a read point zone 120 may be defined by the logical union of read points 116(a), 116(b), and 116(c). Note that the read points need not overlap in physical space, and that disjoint read points (e.g., read point 116(d)) may also be included in the read point zone if desired. In a preferred embodiment, antennas (i.e., read points defined by the antennas) can be arbitrarily assigned to zones, regardless of whether they are associated with the same reader. That is, referring to FIG. 1, antennas 106(b) and 106(c), while both associated with reader 108(b), may be part of different zones. Controller 102 then receives all tag data from readers 108 via respective data links 103 (e.g., wired communication links, 802.11 connections, or the like), then aggregates and filters this data based on zone information. The read point zones are suitably preconfigured by a user or administrator. That is, the user is allowed to access controller 110 and, through a configuration mode, specify a set of read points that are to be included in a particular zone.

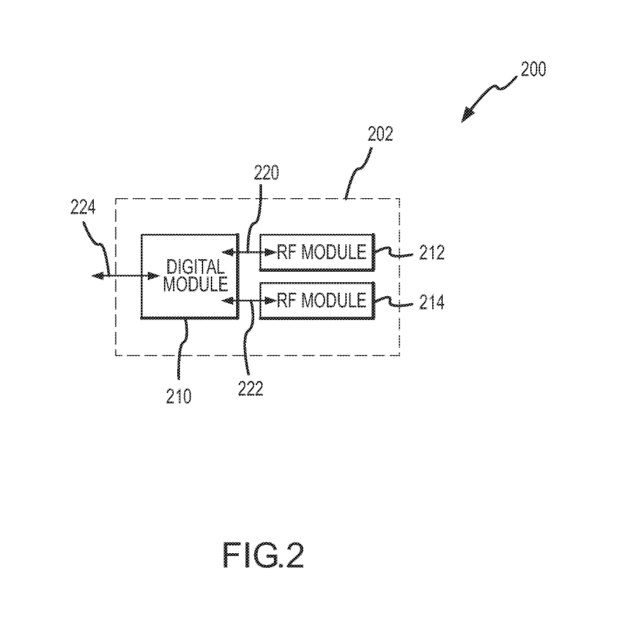

Referring to FIG. 2, in accordance with the present invention, a modular RF-port (or simply “RF port”) 200 includes a housing 202 (having any arbitrary shape, and manufactured from plastic, metal, or any other convenient material), and a digital module 210 within housing 202. RF port 200 is configured such that two or more RF submodules (or simply “submodules”) 212 and 214 may be removeably located within (or attached to) housing 202. That is, RF submodules 212 are removeably coupled to digital module 210, electrically, and may be removeably inserted within housing 202. In an alternate embodiment, submodules 212 and 214 are removeably attached to the exterior of housing 202, which encloses digital model 210. RF port 200 is not limited to two submodules, and may be configured to accommodate 3, 4, or even more such submodules.

RF submodules 212 and 214 may include a variety of electrical components that communicate via RF energy and which can communicate with digital module 210 through connections 220 and 222, respectively. In general, RF submodules 212, 214 are capable of fulfilling many of the functions of the components illustrated in FIG. 1. Example RF submodules useful in various embodiments include RFID reader submodules, 802.11a/b/g access port submodules, 802.11n access port submodules, Wi-MAX (802.16d, 802.16e) submodules, Ultra Wide Band submodules, Bluetooth submodules, etc.

Interfaces 220 and 222 between digital module 210 and submodules 212 and 214, respectfully, may comprise any suitable combination of mechanical connection and corresponding protocol. Suitable interfaces include, for example, USB, PCI-Express, and UART.

Digital module 210 includes one or more microprocessors, memory devices, network interface devices, as well as associated software necessary to manage operation of RF submodules 212 and 214. Data connection 224 may be an Ethernet connection (e.g., GigE), or any other suitable data connection type. One of the two submodules 212 and 214 may be used to connect to a backhaul or other network (i.e., one submodule may be an RFID reader, while another is an 802.11 module). The 802.11 module may then be used to connect to the wireless network such that it becomes a “pure” wireless reader.

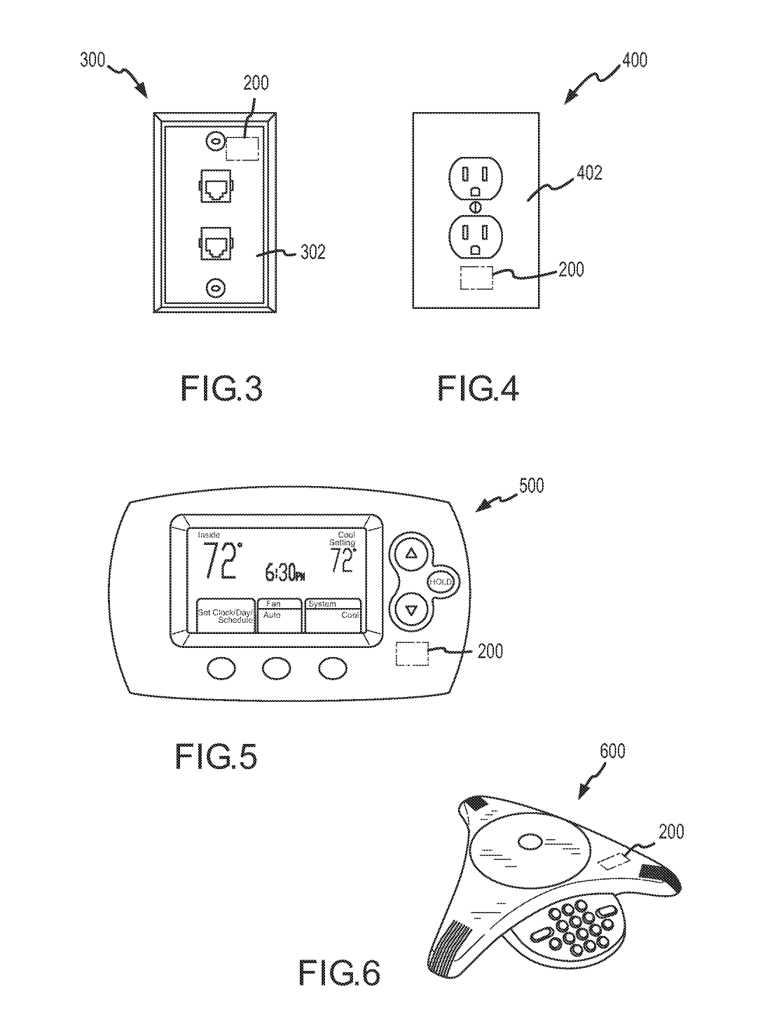

Housing 202 may have any suitable size and shape, but in one embodiment is configured to be small enough to fit within a fixture of the type typically located in residential or commercial buildings—i.e., Ethernet jacks, power outlets, and the like. In one embodiment, housing 202 is shaped to fit within less than a 1.0 in³ volume; however, the size of the housing is not limited. Although the present invention may be employed in any number of applications, FIGS. 3-6 show exemplary environments in which RF port 200 may be installed. FIG. 3, for example, shows a standard Ethernet jack 300 attached to a wall, wherein RF port 200 is located in back of a faceplate 302 (i.e., within the wall). FIG. 4 similarly shows a standard power outlet 400, wherein RF port 200 is installed behind faceplate 402.

FIG. 5 depicts a temperature control device (e.g., a thermostat) 500 with an embedded RF port 200, and FIG. 6 illustrates an RF port 200 installed within a speakerphone system 600. Indeed, RF port 200 may be inserted into any electronic device or assembly, such as projector wall jacks, fire alarms, network cable, etc. Alternatively, RF port 200 may be configured as a stand-alone device that plugs into any convenient outlet or jack (e.g., a wall power outlet or Ethernet wall jack).

In each of these illustrated embodiments, power to digital module 210 and/or submodules 212, 214 may be provided via connection 224 (e.g., power-over-Ethernet), or through an external source that is available at that particular location.

It should be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. An RF port device comprising:
a housing; and
a digital module within the housing, the digital module configured to communicate with a network over a data connection;
the digital module and housing configured to removeably couple to two or more RF submodules.

2. The RF port device of claim 1, wherein the data connection is a GigE Ethernet connection.

3. The RF port device of claim 1, wherein the digital module and the RF submodules receive power from an Ethernet connection.

4. The RF port device of claim 1, wherein the digital module is configured to removeably couple to RF submodules selected from the group consisting of an RFID reader submodule, an 802.11a/b/g access port submodule, an 802.11n access port submodule, a Wi-MAX submodule, an Ultra Wide Band submodule, and a Bluetooth submodule.

5. The RF port device of claim 1, wherein the housing is configured to fit within a 1.0 in³ volume.

6. The RF port device of claim 1, wherein the housing is configured to fit within an Ethernet jack.

7. The RF port device of claim 1, wherein the housing is configured to fit within a power outlet.

8. The RF port device of claim 1, wherein the housing is configured to removeably attach, mechanically and electrically, to a power outlet or network cable wall jack.

9. An RF jack device comprising:
a housing;
a connector extending from the housing, the connector configured to removeably attach to an outlet;
a digital module within the housing, the digital module configured to communicate with a network over a data connection, wherein the housing is configured to removeably attach to two or more RF submodules.

10. The RF jack device of claim 9, wherein the digital module is configured to communicate over a GigE Ethernet connection.

11. The RF jack device of claim 9, wherein the digital module is configured to removeably couple to RF submodules selected from the group consisting of an RFID reader submodule, an 802.11a/b/g access port submodule, an 802.11n access port submodule, a Wi-MAX submodule, an Ultra Wide Band submodule, and a Bluetooth submodule.

12. The RF jack device of claim 9, wherein the housing is configured to fit within a 1.0 in³ volume.

13. The RF jack device of claim 9, wherein the connector is configured to removeably attach to a standard power outlet.

14. The RF jack device of claim 9, wherein the connector is configured to removeably attach to an Ethernet wall jack.

15. A wireless communication method comprising the steps of:
providing a digital module within a housing, the digital module configured to communicate with a network over a data connection, wherein the digital module and housing is configured to removeably couple to two or more RF submodules;
coupling at least one RF submodule to the housing;
removeably connecting the digital module to the network.

16. The method of claim 15, wherein the coupling step includes coupling to the digital module a submodule selected from the group consisting of an RFID reader submodule, an 802.11a/b/g access port submodule, an 802.11n access port submodule, a Wi-MAX submodule, an Ultra Wide Band submodule, and a Bluetooth submodule.

17. The method of claim 15, wherein removeably connecting the digital module includes connecting the digital module to an Ethernet jack.

18. The method of claim 15, wherein removeably connecting the digital module includes connecting the digital module to a power outlet.

19. The method of claim 15, wherein removeably connecting the digital module includes inserting the digital module within an electronic assembly.

20. The method of claim 19, wherein the electronic device is selected from the group consisting of a telephone device, a projector wall jack, an Ethernet jack, a power outlet, a thermostat device, and a fire alarm device.
